(19) United States
(12) Patent Application Publication
(10) Pub. No.: US 2012/0073856 A1
(43) Pub. Date: Mar. 29, 2012

(54) BRAID CONFIGURATIONS IN COAXIAL CABLES

(75) Inventor: NOAH P. MONTENA, Syracuse, NY (US)

(73) Assignee: JOHN MEZZALINGUA ASSOCIATES, INC., East Syracuse, NY (US)

(21) Appl. No.: 12/889,819

(22) Filed: Sep. 24, 2010

(51) Int. Cl. H01B 11/18

(52) U.S. Cl. 174/105 R; 174/107; 174/106 R

(57) ABSTRACT

Braid configurations in coaxial cables. In one example embodiment, a coaxial cable includes a center conductor surrounded by a dielectric, a first braid surrounding the dielectric, a second braid surrounding and adjacent to the first braid, and a jacket surrounding the second braid. The first braid is formed from a first material that is a conductive material. The second braid is formed from a second material that is more compressible and/or has a lower frictional coefficient than the first material.

### BACKGROUND

Coaxial cable often includes an outer protective jacket that serves to protect the internal components of the cable from external contaminants and/or forces. For example, a typical coaxial cable includes a center conductor surrounded by a dielectric, an outer conductor, and a protective jacket. Some protective jackets are made from a relatively rigid material in order to protect the internal components of the cable. A cable with a rigid protective jacket can be especially useful when the cable is installed outdoors, whether aerially or underground, due to the extra protection provided by such a jacket.

Unfortunately, the rigidity of the protective jacket can give rise to several problems. For example, a coaxial cable with a rigid protective jacket can be very difficult to terminate with a typical cable connector. A typical cable connector utilizes a post (or similar structure) that must slide underneath and thereby expand the protective jacket to be properly installed. A rigid protective jacket can require a high insertion force to fully and properly insert the post underneath the jacket. Further, because plastics become more rigid as they are exposed to lower temperatures, the required amount of insertion force increases with any drop in the ambient temperature of the cable. Consequently, cold weather installation of a typical cable connector can be very difficult or even impossible on a cable that includes a rigid protective jacket.

### SUMMARY OF SOME EXAMPLE EMBODIMENTS

In general, example embodiments of the present invention relate to braid configurations in coaxial cables. The example braid configurations disclosed herein generally reduce the amount of insertion force required to fully insert the post of a typical cable connector underneath the jacket of a coaxial cable, even when the coaxial cable is exposed to low temperature conditions.

In one example embodiment, a coaxial cable includes a center conductor surrounded by a dielectric, a first braid surrounding the dielectric, a second braid surrounding and adjacent to the first braid, and a jacket surrounding the second braid. The first braid is formed from a first material that is a conductive material. The second braid is formed from a second material that is more compressible and/or has a lower frictional coefficient than the first material.

In another example embodiment, a coaxial cable includes a center conductor surrounded by a dielectric, a first braid surrounding the dielectric, a second braid surrounding and adjacent to the first braid, and a jacket surrounding the second braid. The first braid is formed from a first material and the second braid is formed from a second material. The second material is a conductive material. The first material is more compressible and/or has a lower frictional coefficient than the second material.

In yet another example embodiment, a coaxial cable includes a center conductor surrounded by a dielectric, a braid surrounding the dielectric, and a jacket surrounding the braid. The braid includes a plurality of wires formed from a first material, and a plurality of strands formed from a second material. The first material is a conductive material and the second material is more compressible and/or has a lower frictional coefficient than the first material.

In still another example embodiment, a coaxial cable includes a center conductor surrounded by a dielectric, a first conductive layer surrounding the dielectric, a braid surrounding and adjacent to the first conductive layer, a second conductive layer surrounding and adjacent the braid, and a jacket surrounding the braid. The braid is formed from a dielectric material.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

Aspects of example embodiments of the present invention will become apparent from the following detailed description of example embodiments given in conjunction with the accompanying drawings, in which:

FIG. 1A is a perspective view of an example coaxial cable that terminates on one end with an example connector and that is prepared for termination on the other end with another identical connector;

FIG. 1B is a perspective view of a portion of the example coaxial cable of FIG. 1A with portions of each layer cut away;

FIG. 1C is a radial cross-sectional view of the example coaxial cable of FIG. 1B;

FIG. 1D is an axial cross-sectional view of the example coaxial cable and one of the example connectors of FIG. 1A;

FIG. 1E is a radial cross-sectional view of the example coaxial cable and one of the example connectors of FIG. 1A;

FIG. 2A is a perspective view of a portion of a first alternative coaxial cable with portions of each layer cut away;

FIG. 2B is a radial cross-sectional view of the first alternative coaxial cable of FIG. 2A;

FIG. 3A is a perspective view of a portion of a second alternative coaxial cable with portions of each layer cut away;

FIG. 3B is a radial cross-sectional view of the second alternative coaxial cable of FIG. 3A; and

FIG. 3C is an enlarged view of a portion of the perspective view of FIG. 3A.

### DETAILED DESCRIPTION OF SOME EXAMPLE EMBODIMENTS

Example embodiments of the present invention relate to braid configurations in coaxial cables. The example braid configurations disclosed herein generally reduce the amount of insertion force required to fully insert the post of a typical cable connector underneath the jacket of a coaxial cable, even when the coaxial cable is exposed to low temperature conditions. In the following detailed description of some example embodiments, reference will now be made in detail to example embodiments of the present invention which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### I. First Example Coaxial Cable

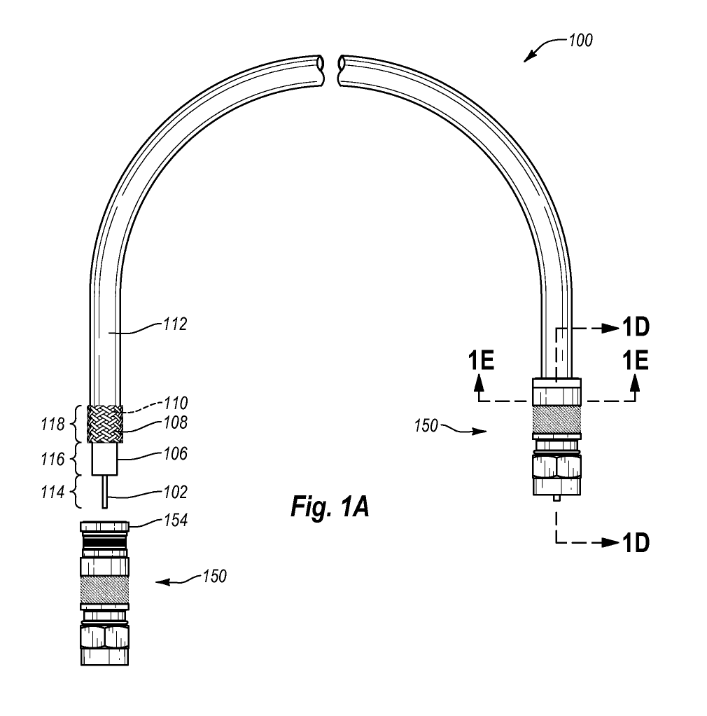

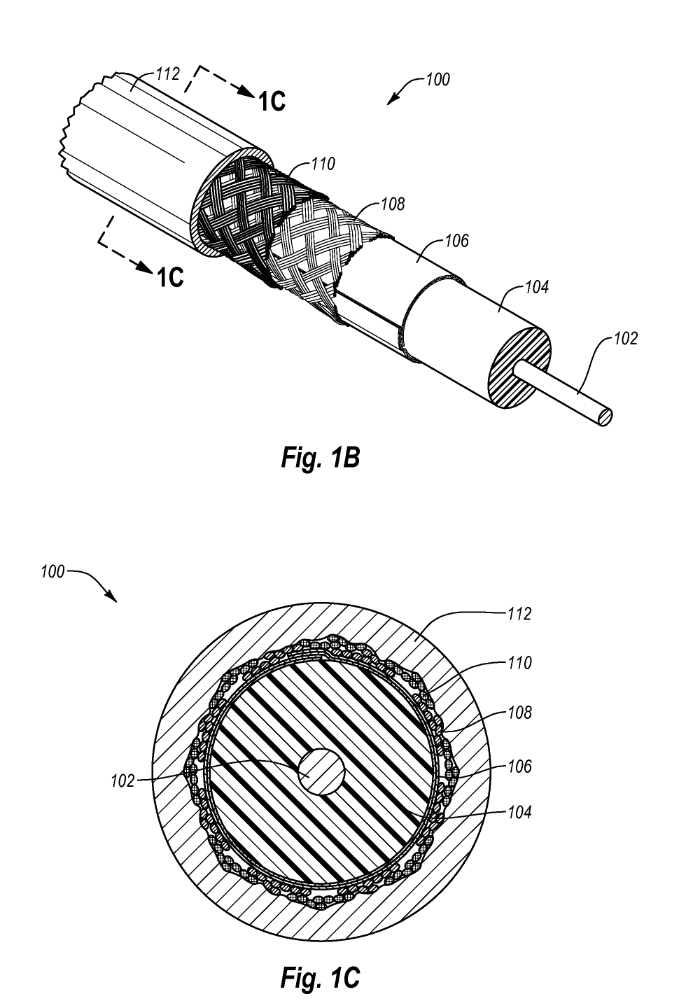

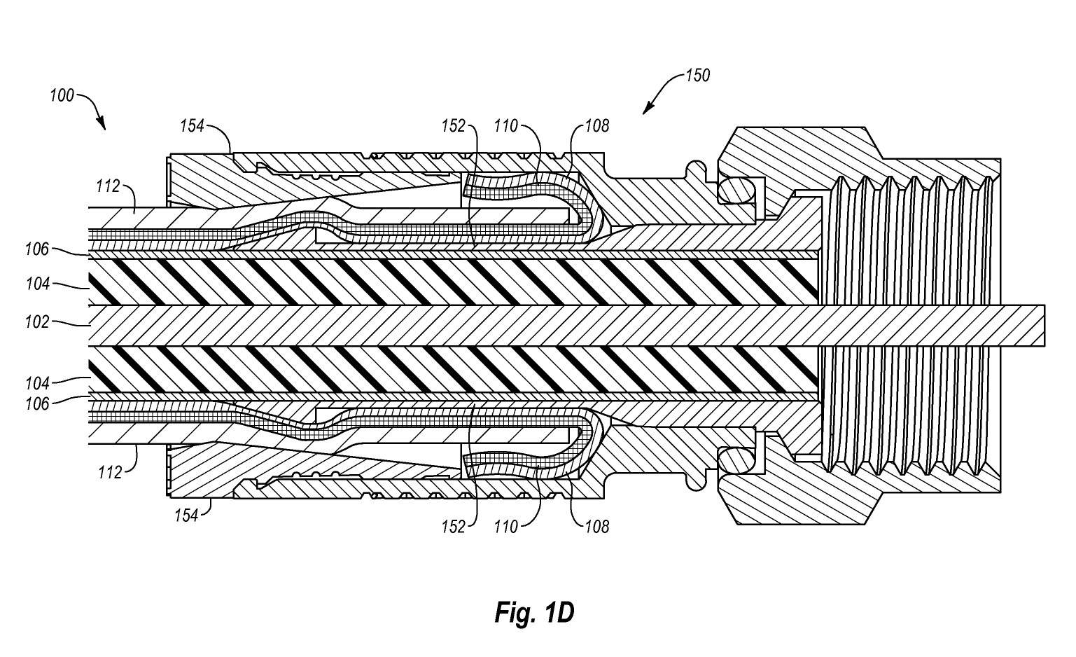

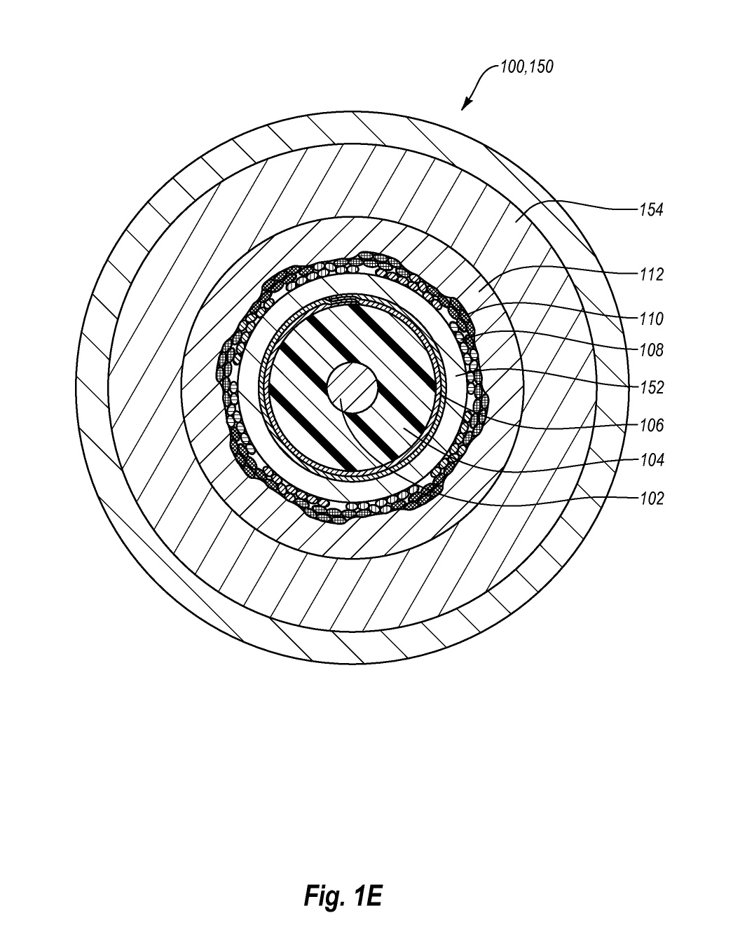

With reference first to FIG. 1A, an example coaxial cable 100 is disclosed. The example coaxial cable 100 can be any type of coaxial cable including, but not limited to, 50 Ohm and 75 Ohm coaxial cable. As disclosed in FIG. 1A, the example coaxial cable 100 is terminated on the right side of FIG. 1A with an example connector 150, and is prepared for termination on the left side of FIG. 1A with a second identical connector 150, as discussed in greater detail below. Although connectors 150 are disclosed in FIG. 1A as F-type male connectors, it is understood that cable 100 can also be terminated with other types of male and/or female connectors (not shown).

With continuing reference to FIG. 1A, and with reference also to FIGS. 1B and 1C, the coaxial cable 100 generally includes a center conductor 102 surrounded by a dielectric 104, an optional conductive tape 106 surrounding the dielectric 104, a first braid 108 surrounding the conductive tape 106, and a second braid 110 surrounding the first braid 108, and a jacket 112 surrounding the second braid 110. As used herein, the phrase “surrounded by” refers to an inner layer generally being encased by an outer layer. However, it is understood that an inner layer may be “surrounded by” an outer layer without the inner layer being immediately adjacent to the outer layer. The term “surrounded by” thus allows for the possibility of intervening layers. Each of these components of the example coaxial cable 100 will now be discussed in turn.

The center conductor 102 is positioned at the core of the example coaxial cable 100. The center conductor 102 can be configured to carry a range of electrical current (amperes) and/or propagate an RF/electronic digital signal. In some example embodiments, the center conductor 102 is formed from solid copper, copper-clad aluminum (CCA), copper-clad steel (CCS), or silver-coated copper-clad steel (SCCCS), although other conductive materials are possible. For example, the center conductor 102 can be formed from any type of conductive metal or alloy. In addition, the center conductor 102 can be solid, hollow, stranded, corrugated, plated, or clad, for example.

The dielectric 104 surrounds the center conductor 102, and generally serves to support and insulate the center conductor 102 and the outer conductive tape 106. Although not shown in the figures, a bonding agent, such as a polymer, can be employed to bond the dielectric 104 to the center conductor 102. In some example embodiments, the dielectric 104 can be, but is not limited to, taped, solid, or foamed polymer or fluoropolymer. For example, the dielectric 104 can be foamed polyethylene (PE).

The optional tape 106 surrounds the dielectric 104 and generally serves to minimize the ingress and egress of high frequency electromagnetic radiation to/from the center conductor 102. For example, in some applications, the tape 106 can shield against electromagnetic radiation with a frequency greater than or equal to about 50 MHz. The tape 106 is a laminate tape that can include, but is not limited to, the following layers: aluminum/polymer, bonding agent/aluminum/polymer, bonding agent/aluminum/polymer/aluminum, or aluminum/polymer/aluminum, for example. It is understood, however, that the discussion herein of tape is not limited to tape having any particular combinations of layers.

The first braid 108 surrounds the tape 106. The first braid 108 is formed from a conductive material, such as aluminum or copper, and generally serves to minimize the ingress and egress of low frequency electromagnetic radiation to/from the center conductor 102. For example, in some applications, the braid 108 can shield against electromagnetic radiation with a frequency less than about 50 MHz. In addition, the braid 108 also serves to give structural support to, and thereby strengthen, the coaxial cable 100. The braid 108 can be formed from inter-woven, fine gauge aluminum or copper wires, such as 34 American wire gauge (AWG) wires, for example. It is understood, however, that the discussion herein of braid is not limited to braid formed from any particular type or size of wire.

The second braid 110 surrounds the first braid 108. The second braid 110 is formed from a material that is more compressible and/or has a lower frictional coefficient than the material from which the first braid 108 is formed. For example, where the first braid 108 is formed from aluminum or copper, the second braid 110 may be formed from an elastomer, a polymer, glass, carbon fiber, aramid fiber, or some combination thereof. One suitable elastomer is silicone rubber. One suitable polymer is nylon. In one example embodiment, the second braid 110 may be woven from a nylon monofilament.

The compressibility and/or relatively low frictional coefficient of the material from which the second braid 110 is formed may be enhanced by weaving the strands of the second braid 110 less tightly than the wires of the first braid 108 are woven. For example, where the first braid 108 has 90% braid coverage, the second braid 110 may have 70% braid coverage. Also, the compressibility and/or relatively low frictional coefficient of the material from which the second braid 110 is formed may be enhanced by forming the strands of the second braid 110 to have a gauge that is less than the gauge of the wires of the first braid. Further, it is understood that some strands of the second braid 110 may be formed from one compressible and/or relatively low frictional coefficient material, while other strands of the second braid 110 are formed from another compressible and/or relatively low frictional coefficient material.

The jacket 112 surrounds the second braid 110, and generally serves to protect the internal components of the coaxial cable 100 from external contaminants, such as dust, moisture, and oils, for example. In a typical embodiment, the jacket 112 also functions to limit the bending radius of the cable to prevent kinking, and functions to protect the cable (and its internal components) from being crushed or otherwise misshapen from an external force. The example jacket 112 can be formed from a relatively rigid material such as, but not limited to, polyethylene (PE), high-density polyethylene (HDPE), low-density polyethylene (LDPE), linear low-density polyethylene (LLDPE), or some combination thereof. The actual material used might be indicated by the particular application/environment contemplated.

With reference now to FIG. 1D, and also with reference again to FIG. 1A, aspects of termination of the example cable 100 with the example connector 150 are disclosed. As disclosed on the left side of FIG. 1A, prior to the termination of the example coaxial cable 100 with the connector 150, a quarter-inch section 114 of the center conductor 102 and a quarter-inch section 116 of the tape 106 are exposed. The quarter-inch section 114 of the center conductor 102 is exposed by removing the jacket 112, the second braid 110, the first braid 108, the tape 106, and the dielectric 104. The quarter-inch section 116 of the tape 106 is exposed by removing the jacket 112 and then folding back a quarter-inch section 118 of the first and second braids 108 and 110 over the outside of the jacket 112. Next, a cylindrical post 152 (or similar structure) of the cable connector 150 can be inserted between the tape 106 and the first braid 108. Finally, a wedge portion 154 of the connector 150 can be slid down the coaxial cable 100 into the connector 150 in order to firmly attach the connector 150 to the coaxial cable 100.

With continuing reference to FIG. 1D, and with reference now also to FIG. 1E, additional aspects of termination of the example cable 100 with the example connector 150 are disclosed. As previously noted, jackets made entirely from a rigid, substantially non-compressible material such as PE tend to require an excessive amount of insertion force to fully insert the post of a cable connector (or similar component) underneath the jacket. However, as disclosed in FIG. 1E, as the post 152 of the cable connector 150 is inserted between the tape 106 and the first braid 108, the post 152 displaces the strands of the second braid 110 by causing the strands to compress and/or slip into unoccupied space around the strands.

The displacement of the strands of the second braid 110 into the unoccupied space around the strands is possible because the second braid 110 is not embedded in a solid layer but is instead woven, which inherently results in region of unoccupied space around the strands between the surrounding solid layers, namely, the tape 106 and the jacket 112. Where the strands of the second braid 110 are more compressible that the wires of the first braid 108, the strands can deform into this unoccupied space. Where the strands of the second braid 110 have a lower frictional coefficient than the wires of the first braid 108, the strands can slip past each other, or past the wires of the first braid 108, into this unoccupied space. A lower frictional coefficient allows the strands to move more freely relative to other strands with less surface adhesion.

The displacement of the strands of the second braid 110 into the unoccupied space around the strands reduces the displacement of the jacket 112 that is required to fully insert the post 152. Since the strands of the second braid 110 are more easily displaced than the jacket 112, the relative decrease in the displacement of the jacket 112 reduces the amount of insertion force required to fully insert the post 152 of the connector 150 underneath the jacket 112.

Further, the second braid 110 is particularly advantageous in low ambient temperatures. For example, although cold weather installation of the cable connector 150 onto a standard rigid-jacketed cable can be difficult or impossible due to the increased rigidity of the jacket in cold temperatures, the cable connector 150 can be installed with relative ease onto the example coaxial cable 100 in cold weather due to the required insertion force being considerably reduced by virtue of the compressible and/or relatively low frictional coefficient second braid 110. Therefore, the cable connector 150 can be installed on the example coaxial cable 100 in cold weather where installation was previously difficult or impossible with a standard rigid-jacketed cable. At the same time, the relatively rigid jacket 112 provides the protection necessary for the internal components of the coaxial cable 100.

In addition to the benefits of the second braid 110 discussed above, the second braid 110 may also contribute to the tensile and torsional strength and kink resistance of the coaxial cable 100. In addition, to the extent that the inclusion of the second braid 110 reduces the thickness of the jacket 112 to maintain a consistent outer diameter of the jacket 112, and to the extent that the second braid 110 is formed from a material that is lighter and/or less dense than the material from which the jacket 112 is formed, the inclusion of the second braid 110 can reduce the weight of the coaxial cable 100.

### II. Alternative Coaxial Cables

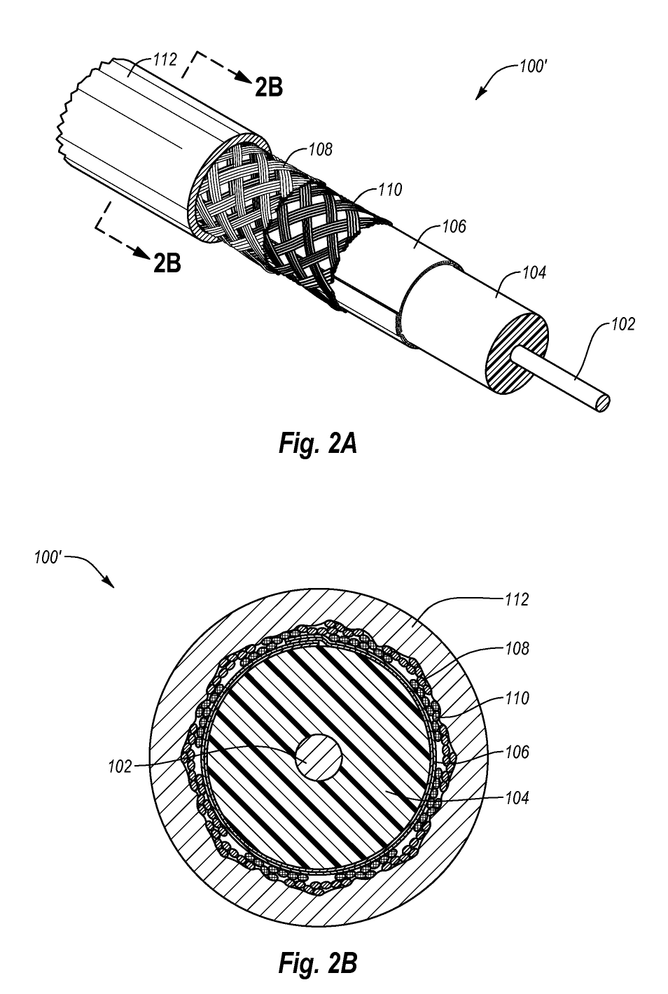

It is understood that various alternative braid configurations are contemplated to achieve the reduced amount of insertion force required to fully insert a post of a connector underneath the jacket of a coaxial cable. For example, with reference to FIGS. 2A and 2B, a first alternative coaxial cable 100′ includes first and second braids 108 and 110 but reverses their positions in the cable. In particular, the second braid 110 surrounds the tape 106, and the first braid 108 surrounds the second braid 110 in the first alternative coaxial cable 100′.

As noted above, the second braid 110 is formed from a material that is more compressible and/or has a lower frictional coefficient than the material from which the first braid 108 is formed. Accordingly, as a post of a cable connector (such as the connector 150 disclosed in FIGS. 1D and 1E for example) is inserted between the tape 106 and the second braid 110 of the first alternative coaxial cable 100′, the post displaces the strands of the second braid 110 by causing the strands of the second braid 110 to compress and/or slip into unoccupied space around the strands, which reduces the amount of insertion force required to fully insert the post of the connector underneath the jacket 112.

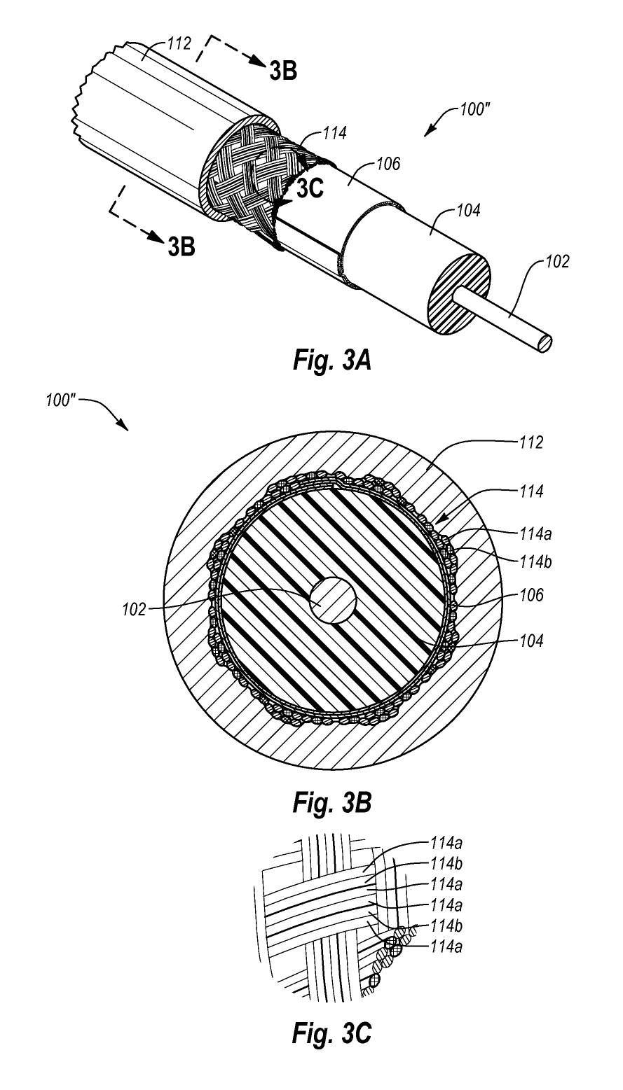

With reference to FIGS. 3A-3C, a second alternative coaxial cable 100″ includes a hybrid braid 114. As disclosed in FIGS. 3B and 3C, the hybrid braid 114 includes a plurality of interwoven wires 114a and strands 114b. The wires 114a are formed from the same materials discussed above in connection with the first braid 108 and the strands 114b are formed from the same materials discussed above in connection with the second braid 110. For example, the wires 114a may be formed from aluminum or copper, and the strands 114b may be formed from an elastomer such as silicone rubber. As disclosed in FIG. 3C, two wires 114a are surrounded by two strands 114b, which are in turn surrounded by two more wires 114a. Therefore, in the embodiment disclosed in FIGS. 3A-3C, the hybrid braid 114 includes twice as many wires 114a as strands 114b. It is understood, however, that other ratios of wires 114a and strands 114b are contemplated. For example. The ratios of wires 114a to strands 114b may be greater than or less than 2:1.

As noted above, the material from which the wires 114a are formed is more compressible and/or has a lower frictional coefficient than the material from which the strands 114b are formed. Accordingly, as a post of a cable connector (such as the connector 150 disclosed in FIGS. 1D and 1E for example) is inserted between the tape 106 and the hybrid braid 114 of the second alternative coaxial cable 100″, the post displaces the strands 114b of the braid 114 by causing the strands 114b of the braid 114 to compress and/or slip into unoccupied space around the strands 114b, which reduces the amount of insertion force required to fully insert the post of the connector underneath the jacket 112.

Finally, although the example coaxial cables 100, 100′, and 100″ disclosed herein include a single tape layer and one or two braid layers, it is understood that the example braid configurations disclosed herein may be employed in coaxial cables having: zero tape layers or two or more tape layers; three or more braid layers; or a messenger wire; or having some combination thereof. For example, a coaxial cable may include the hybrid braid 114, as disclosed above in connection with the coaxial cable 100″, and also include one or more first braid layers 108 and/or one or more second braid layers 110, as disclosed above in connection with the coaxial cables 100 and 100′.

In addition, it is understood that the second braid layer 110 may be employed as an insulator between two conductive layers. For example, where the second braid layer 110 is formed from a dielectric material, the second braid layer 110 may be positioned between two conductive braid layers 108, between two conductive tape 106 layers, or between one conductive braid layer 108 and one conductive tape layer 106 in order to insulate the two conductive layers from one another. Therefore, the second braid layer 110, when formed from a dielectric material, can function to isolate two adjacent conductive layers.

The example embodiments disclosed herein may be embodied in other specific forms. The example embodiments disclosed herein are to be considered in all respects only as illustrative and not restrictive.

What is claimed is:

1. A coaxial cable comprising:
a center conductor surrounded by a dielectric;
a first braid surrounding the dielectric, the first braid formed from a first material comprising a conductive material;
a second braid surrounding and adjacent to the first braid, the second braid formed from a second material that is more compressible and/or has a lower frictional coefficient than the first material; and
a jacket surrounding the second braid.

2. The coaxial cable as recited in claim 1, wherein the first material comprises aluminum or copper.

3. The coaxial cable as recited in claim 1, wherein the second braid is less tightly woven than the first braid.

4. The coaxial cable as recited in claim 1, wherein strands of the second braid have a gauge that is smaller than a gauge of wires of the first braid.

5. The coaxial cable as recited in claim 1, wherein the second material comprises a polymer or an elastomer.

6. The coaxial cable as recited in claim 5, wherein the second material comprises nylon.

7. The coaxial cable as recited in claim 1, wherein the second material comprises glass.

8. The coaxial cable as recited in claim 1, wherein the second material comprises carbon fiber or aramid fiber.

9. A coaxial cable comprising:
a center conductor surrounded by a dielectric;
a first braid surrounding the dielectric, the first braid formed from a first material;
a second braid surrounding and adjacent to the first braid, the second braid formed from a second material comprising a conductive material, the first material being more compressible and/or having a lower frictional coefficient than the second material; and
a jacket surrounding the second braid.

10. The coaxial cable as recited in claim 9, wherein the second material comprises aluminum or copper.

11. The coaxial cable as recited in claim 9, wherein the first braid is less tightly woven than the second braid.

12. The coaxial cable as recited in claim 9, wherein strands of the first braid have a gauge that is smaller than a gauge of wires of the second braid.

13. The coaxial cable as recited in claim 9, wherein the first material comprises a polymer or an elastomer.

14. The coaxial cable as recited in claim 9, wherein the first material comprises glass.

15. The coaxial cable as recited in claim 9, wherein the first material comprises carbon fiber or aramid fiber.

16. A coaxial cable comprising:
a center conductor surrounded by a dielectric;
one or more braids surrounding the dielectric, the one or more braids comprising:
a plurality of wires formed from a first material; and
a plurality of strands formed from a second material, the first material comprising a conductive material and the second material being more compressible and/or having a lower frictional coefficient than the first material; and
a jacket surrounding the braid.

17. The coaxial cable as recited in claim 16, wherein the first material comprises aluminum or copper.

18. The coaxial cable as recited in claim 17, wherein the wires are interwoven with the strands.

19. The coaxial cable as recited in claim 17, wherein the second material comprises a polymer or an elastomer.

20. The coaxial cable as recited in claim 17, wherein the second material comprises carbon fiber or aramid fiber.

21. A coaxial cable comprising:
a center conductor surrounded by a dielectric;
a first conductive layer surrounding the dielectric;
a braid surrounding and adjacent to the first conductive layer, the braid formed from a dielectric material;
a second conductive layer surrounding and adjacent the braid; and
a jacket surrounding the braid.

22. The coaxial cable as recited in claim 21, wherein the first and second conductive layers are braid layers.

23. The coaxial cable as recited in claim 21, wherein the first and second conductive layers are tape layers.

24. The coaxial cable as recited in claim 21, wherein the one of the conductive layers is a braid layer and the other conductive layer is a tape layer.
